(19) United States
(12) Patent Application Publication
(10) Pub. No.: US 2005/0118070 A1
(43) Pub. Date: Jun. 2, 2005

(54) Flow triggering device

(76) Inventors: Patrick Griss, Zurich (CH); Vuk Siljegovic, Brunnen (CH); Martin Kopp, Hagendorn (CH)

Correspondence Address: Roche Diagnostics Corporation, 9115 Hague Road, PO Box 50457, Indianapolis, IN, 46250-0457, US

(21) Appl. No.: 10/971,859

(22) Filed: Oct. 22, 2004

(30) Foreign Application Priority Data
Oct. 23, 2003 (EP) EP 03 024 419.8

(51) Int. Cl. B01L 3/02; B32B 5/02; B32B 27/04; B65D 37/00; B32B 27/12

(52) U.S. Cl. 422/100

(57) ABSTRACT

The present invention is related to a microfluidic device capable of conveying a liquid by capillary forces. The microfluidic device comprises a microfluidic channel system comprising i) a liquid supply compartment; ii) a first channel connected to the liquid supply compartment, having at least one non-closing valve located downstream of the liquid supply compartment; and iii) a second channel. The second channel branches-off from the first channel downstream of the liquid supply compartment but upstream of the at least one non-closing valve and which re-unites with the first channel at the location of the non-closing valve to form an outlet channel. The second channel does not contain any non-closing or closing valve thus creating an unobstructed liquid flow path connecting the liquid supply compartment with the outlet channel.

### BACKGROUND OF THE INVENTION

The present invention is related to the control of the flow behaviour of liquid driven by capillary forces in microfluidic devices.

### SUMMARY OF THE INVENTION

The present invention provides certain unobvious advantages and advancements over the prior art. In particular, the inventors have recognized a need for improvements in flow triggering device design.

Although the present invention is not limited to specific advantages or functionality, it is noted that the present invention provides a device that can considerably slow down or even stop volume flow in a microfluidic chamber or channel. Thus, fluid control enables control of chemical or physical processes, for example, dissolution of dried reagents, in the chamber and/or the control of reaction time. Moreover, the present invention enables one to reliably join a liquid from a multitude of channels with a common inlet port in a bubble-free manner.

In accordance with one embodiment of the present invention, liquid flow in a passive fluidic device can be controlled without external actuation or a control element. The present invention slows down or accelerates liquid flow in the fluidic device according to the present invention. To that end the microfluidic device having at least one non-closing valve and a channel system, within which a channel branches-off from a first channel, which may define a functional chamber and being connected to a fluidic supply, comprises a trigger channel which branches-off from the first channel prior to the non-closing valve and that re-unites with the first-channel at the location of the non-closing valve. By the design of the trigger channel, i.e., its respective length, its number of windings and its flow resistance, the trigger channel can be adapted to specific needs and requirements of the microfluidic device. The length of the trigger channel has a strong impact on the residence time of the liquid within the functional chamber. The longer the distance through which the liquid to be conveyed has to move until it reaches a valve, such as a geometric or passive valve, known as a non-closing valve, the longer is the residence time achievable. By means of the present invention, the control of the flow behaviour of liquid driven by capillary forces can be controlled.

In accordance with the present invention, it is possible either to considerably slow down or even stop liquid flow in a functional chamber to increase the residence time of liquid molecules in the chamber, for example to improve the dissolution of dried reagents within the chamber. Further, a bubble-free reliable joining of liquid from a multitude of channels into one channel is achieved. Besides the dissolution of a dried reagent, being contained within a functional chamber, to give an example, the microfluidic device according to the present invention can be used to control chemical reactions of liquids, to enhance incubation time to mix substances by way of liquid flow control or other specific purposes. The trigger channel does not contain any non-closing valve thus creating an unobstructed liquid flow path connecting the liquid supply compartment with the outlet channel. The triggering function of the trigger channel is established by the respective length thereof. In contrast to U.S. Patent Application Publication No. 2002/0003001 A1, in which two channels are disclosed, each of the channels has a passive valve. Thus, fluid flow in both channels is stopped, if no fluid is present in one of the two channels. According to the present invention, fluid flow within the trigger channel is not stopped, if there is no liquid present in the first channel.

The trigger channel, which controls liquid flow through a network of microchannels contained within a substrate of a microfluidic device or microfluidic network may have a width or a diameter, which is smaller as compared to an inlet channel. The length of the respective trigger channel exceeds a length of the flow path of the liquid from the branch-off location to the non-closing valve.

The microfluidic device according to the present invention comprises a functional chamber which is provided for dissolution of dried reagent within the liquid. By means of the design of the trigger channel which is passed by a portion of the liquid flow, the mixing of the liquid being processed with substances such as dried reagent in the functional chamber can be significantly improved by extending the residence time of the liquid within the functional chamber. In one embodiment of the present invention, the respective trigger channel branches-off from an outlet channel of the functional chamber. The functional chamber may be arranged as a pillar-array; in a further embodiment of the present invention, the respective trigger channel may branch-off from an inlet channel to the respective functional chamber and is directed downstream of a functional chamber and joins an outlet channel downstream of the functional chamber. Thus, in the latter embodiments, non-dissolved or non-processed liquid is used as medium within the branched-off trigger channel instead of processed liquid, within which the dried reagent contained within the functional chamber already have been dissolved.

The trigger channel as disclosed may be used as a trigger channel within a flow splitter device having an array of splitted channels to one of which a trigger channel is assigned. In this flow-splitter device, the openings of each of the microchannels of the array of splitted channels may contain a geometric or passive valve. The splitted channels may be arranged on both sides of a planar substrate overlapping each other, thus forming the geometric passive valves. The first channel is split into the second channel and an array of at least two splitted channels, each of the splitted channels having at least one non-closing valve, located downstream of the branch-off of the second channel and wherein the second channel re-unites with each of the splitted channels of the array downstream of the non-closing valve to form an outlet channel.

Microfluidic devices or microfluidic networks may be etched or replicated, for example by replication by means of plastic injection, hot embossing ceramic replication. One means of replication may be a CD-replication. According to the present invention, the portions of the disk may each comprise a functional chamber, to which a respective trigger channel is assigned, to control liquid flow from a reservoir to a containing element. In the alternative, a cascade arrangement of the microfluidic structures may be comprised on the portions, controlling liquid flow from a liquid storage by the length of a respective trigger channel. Depending on the design of the cascade arrangement a number of microfluidic devices may be arranged on the portions of the CD.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIGS. 1-2 show two embodiments of passive geometric valves;

FIG. 3 shows an inlet and the trigger channel arranged in communication with each other;

FIG. 4 shows a meniscus preventing the flow through the inlet channel according to FIG. 3;

FIG. 5 shows an amount of liquid being stored in the trigger channel;

FIG. 6 shows the liquid volumes in the trigger and inlet channel joining each other forming a common meniscus towards the outlet channel;

FIG. 7 shows an outlet flow of liquid through an outlet channel;

FIG. 8 shows a further alternative embodiment of an inlet and a trigger channel arrangement;

FIGS. 9-12 show schematic embodiments for combining a trigger element with a further functional chamber;

FIG. 13 shows a planar design of flow-splitter device;

FIG. 14 shows a flow-splitter device within which geometric stop valves are generated;

FIGS. 15-17 show fluidic trigger structures to be replicated in plastic for fluidic evaluation; and

FIG. 18 shows schematically a non-closing valve.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiment(s) of the present invention.

### DETAILED DESCRIPTION OF THE INVENTION

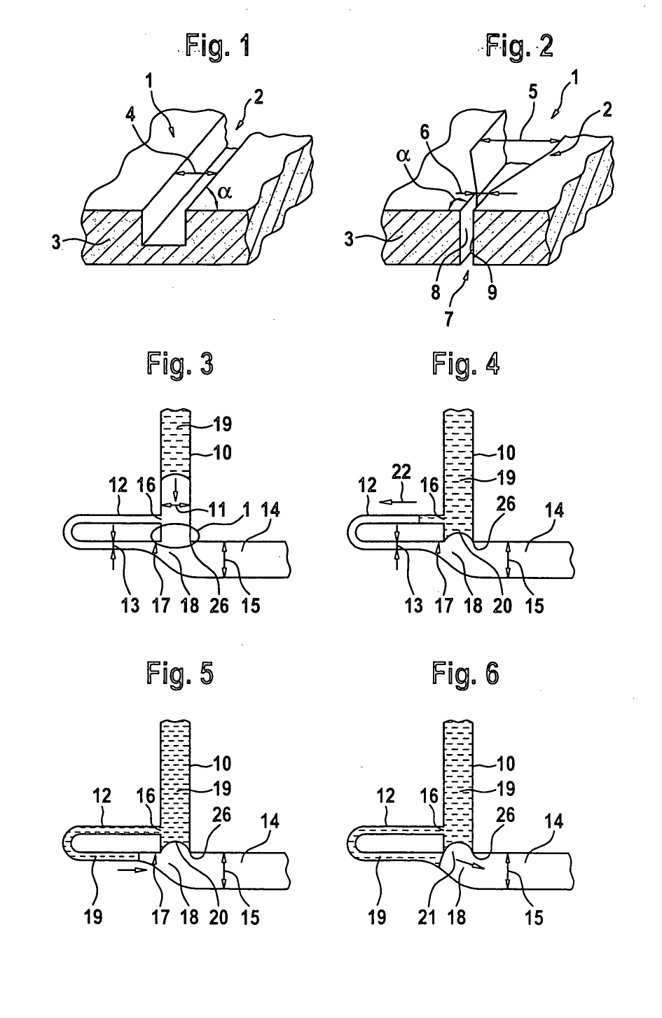

FIGS. 1 and 2 show two embodiments of passive geometric valves which constitute functional elements in the context of the present invention and are known per se. In the microfluidic devices, further described hereinafter, a transport of a liquid 19 is established by capillary forces without application of external energy, created by a pumping element or the like. The transfer of liquid 19 within the microfluidic devices further described below is established by capillary forces. The system liquid 19 surface of channels within which the liquid 19 is conveyed, has a contact angle of less than 90°. It is understood that the respective contact angle as described before can vary according to the type of liquid 19 which is conveyed. Within the system of liquid 19/surface of channels the contact angle can be changed by changing the surface properties of the respective channels, being formed on the front side, the backside, or on both sides of a substrate 3. Materials for the respective substrates are—to give examples—polymeric materials (for example polycarbonate, polystyrol, Poly(methyl methacrylate)) that may be replicated, etchable materials (for example silicon, steel, glass) or materials that may be milled conventionally (for example polycarbonate, polystyrol, Poly(methyl methacrylate), steel).

The examples according to FIGS. 1 and 2, respectively, show known non-closing valves 1. In a substrate 3, a channel 2 is provided forming a non-closing valve 1. The width 4 of channel 2 in the substrate 3 is constant. In the example given in FIG. 1 the channel 2 has a substantially rectangular shape being a U-profile. The open side of the channel 2 on top of the substrate 3 may be covered by a further substrate which is not shown here. Instead of U-profiled channels 2 according to the embodiment given in FIG. 1 the channels 2 may be shaped as tubes with a continuously closed circumference.

A further example of a channel 2 having a non-constant width is given in FIG. 2. The channel 2 according to FIG. 2 has a first width 5 and a second width 6 within the area of a gap 7. A first surface 8 and a second surface 9 of adjacently arranged substrate 3 limit the gap 7. The gap 7 having a second width 6 constitutes a non-closing valve element 1 such as a geometric valve.

FIG. 3 shows an inlet and a trigger channel of a microfluidic device arranged in liquid communication with each other. An inlet channel 10 which either can have the shape of a tube or of a rectangular formed channel such as given in FIG. 1, conveys a liquid 19. The width or in the alternative the diameter of the inlet channel 10 is depicted by reference numeral 11. At a branch-off location 16, a trigger channel 12 branches off from the inlet channel 10. The liquid 19 contained within the inlet channel 10 is propelled by means of capillary forces. Seen in flow direction of the liquid 19, a non-closing valve 1 such as a geometric valve is provided. In this context a non-closing valve 1 refers to valves in which a liquid 19 is stopped at a specific location of a channel even if the channel at the valve position is opened and is not obstructed by physical means. Geometric valves are non-closing valves, in which the valve function is obtained by a specific curvature or geometry of the channel, whereby the surface characteristics are constant with respect to a channel. Reference numeral 17 depicts the area where the trigger channel 12 and the non-closing valve 1 meet, i.e., constituting a joining location.

At the branch-off location 16 the trigger channel 12 branches off. The trigger channel 12 has a diameter or a width, respectively, labelled with reference numeral 13. The diameter or the width 13 of the trigger channel 12 is smaller as compared to the diameter or the width 11 of the inlet channel 10. The length of the trigger channel 12 between the branch-off location 16 and the joining location 17 is substantially higher than the distance within the inlet channel 10 from the branch-off location 16 to the end of the geometric valve 1, i.e., an edge 26 of support element 3 and exceeds the length of the flow path of the liquid from the branch-off location 16 to the non-closing valve.

FIG. 4 shows a meniscus formed, preventing further flow through the inlet channel according to FIG. 3.

Due to the action of the non-closing valve 1, such as a geometric valve, the liquid 19 flowing in the inlet channel 10 is stopped. Due to capillary forces, which depend on the width or the diameter 13, respectively, of the trigger channel 12, some amount of liquid 19 is drawn into the trigger channel 12. The liquid flow between branch off location 16 and joining location 17 is stopped within channel 10 at the first meniscus 20. However, liquid enters slowly into a trigger channel 12. A first meniscus 20 is formed in the region of the non-closing valve 1, such as a geometric valve. In this stage, no liquid 19 is present in the joining location 17 of the outlet channel 14.

FIG. 5 shows an amount of liquid flowing in the length of the trigger channel.

Due to the restricted width or diameter 13 of the trigger channel 12 the liquid 19 needs some time to flow towards the joining location 17 of the trigger channel 12 opening into the funnel-shaped area 18. The first meniscus 20 at the bottom of inlet channel 10 is still prevailing, the fluid flow between branch-off location 16 and joining location 17 is stopped, however liquid slowly enters into trigger channel 12. The liquid 19 stored within the trigger channel 12 has not reached the joining location 17 yet. As long as liquid 19 is present within the trigger channel 12, the main flow of liquid 19 within the inlet channel 10 before the branch-off location 16 is slowed down, when compared to the situation given according to FIG. 3. The flow of liquid 19 within the inlet channel 10 is dependent on the cross section 13 of the trigger channel 12. The narrower channel 12 is as compared to the channel 10, the slower the fluid flows.

FIG. 6 shows the liquid volumes in the trigger channel and the inlet channel joining each other forming a common meniscus towards the outlet channel.

In the stage given in FIG. 6, the liquid 19 stored within the trigger channel 12 has reached the joining location 17. Once the liquid 19 flows out of the trigger channel 12, a second, common meniscus 21 is formed. The liquid 19 consequently is pulled towards the outlet channel 14, having a width or diameter 15, respectively, which may correspond to the cross sections 11, 13 of the inlet channel 10 and the trigger channel 12, respectively. The two flows through the inlet channel 10 and the trigger channel 12 join each other and are drawn due to capillary forces into the outlet channel 14.

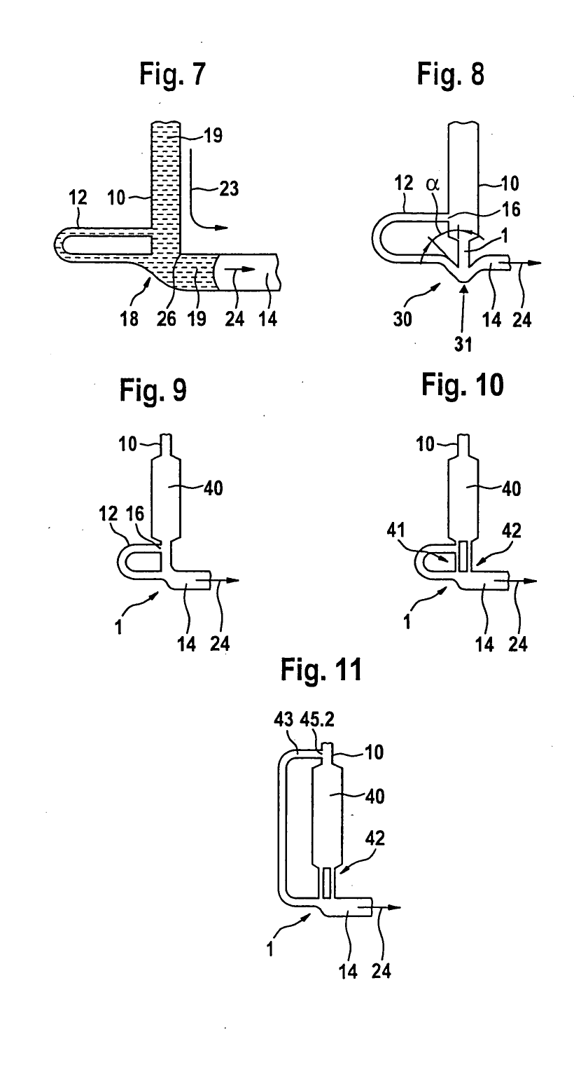

FIG. 7 shows an outlet flow of liquid through the outlet channel.

Once the flow through the trigger channel 12 has reached the joining location 17, opening into outlet channel 14, a main flow 23 of liquid 19 is generated having a flow direction as indicated by reference numeral 24. In the stage according to FIG. 7 the flow through inlet channel 10 has restarted again, whereas a partial volume of liquid 19 still flows within the trigger channel 12. In this stage the non-closing valve 1 at the bottom edge 26 of the inlet channel 10 is no longer active. If the flow resistance in the trigger channel 12 is chosen to be high, the portion of liquid flowing in the trigger channel is very low.

By controlling a flow rate of a liquid 19 in a microfluidic device with no external actuation or control elements the liquid flow can be slowed down considerably or even be stopped, thus increasing the residence time of liquid molecules, for instance in a processing or functional chamber, to improve the dissolution of dried reagents comprised in the functional chamber. Another significant advantage of the trigger channel 12 is a reliable joining of liquids from a multitude of channels, having a common inlet port, such as split inlet channels into one common outlet channel, as will be described in more detail below.

FIG. 8 shows a further alternative embodiment of an inlet channel and a trigger channel arrangement. In the alternative embodiment given in FIG. 8, the inlet channel 10 and the outlet channel 14 are connected to one another by means of a non-closing valve 1 which engages the outlet channel 14 in an arc-shaped recess portion 30 thereof. In the embodiment according to FIG. 8, the angle α between the non-closing valve 1 and the end of the trigger channel 12 is about 45°, whereas the angle α according to the embodiments given in FIGS. 1 and 2, respectively, is about 90°. The angle α between in the joining area of the trigger channel 12 and the non-closing valve 1 can be chosen depending on the properties of the system surface/liquid and other specific requirements, for example the size and the material of the substrate 3 or the like. The material of the substantially plane substrate 3 may be chosen from one of the below listed materials: polymeric materials (for example polycarbonate, polystyrol, Poly(methyl methacrylate)) that may be replicated, etchable materials (for example silicon, steel, glass) or materials that may be milled conventionally (for example polycarbonate, polystyrol, Poly(methyl methacrylate), steel). The respective inlet channels 10, outlet channels 14 and the trigger channel 12 may be manufactured in silicon substrates by etching or plastic replication.

FIGS. 9-12 show schematic embodiments of a microfluidic device provided with a functional chamber.

A functional chamber 40 may allow functions such as for dissolving dried reagents. To dissolve the dried reagents within the functional chamber 40 an increase of the residence time of the liquid molecules of the liquid 19 is advantageous. The functional chamber 40 further may serve the purpose to allow for chemical reactions, dissolving dry reagents, or for mixing up substances. A further function to be performed in the functional chamber 40 is the incubation, i.e., to lengthen the residence time of liquid. Depending on the system liquid 19/dried reagents the time interval within which the dried reagents are dissolved, may vary considerably. Thus, the respective residence time of the mixture liquid 19 and dried reagents can be adapted depending on the dissolving time of each system liquid 19/dried reagents. This is possible by varying the length of the trigger channel 12, which does itself not contain any non-closing valve, thus creating an unobstructed liquid flow path connecting the liquid supply compartment with the outlet channel 14.

The trigger channel 12, as described in connection with the embodiments according to FIGS. 3-8 in greater detail above, allows a functional chamber 40 to be filled with a liquid 19. Once the liquid 19 reaches the non-closing valve 1, the flow rate into the functional chamber 40 is considerably lowered to allow for more time for specific functions to take place in the functional chamber 40 as mentioned above. The functional chamber 40 may be constituted as a simple liquid container or may contain an array of pillars or even may contain a number of liquid channels. It is further conceivable to form the first channel which is connected to a fluid supply as a functional chamber.

In the embodiment according to FIG. 9 by means of the inlet channel 10 the functional chamber 40 may be filled with a liquid 19. To the outlet of the functional chamber 40 according to the embodiment given in FIG. 9 a trigger channel 12 is assigned. The outlet of the functional chamber 40 constitutes the inlet with respect to the non-closing valve element 1 which is arranged below the functional chamber 40. At a branch-off location 16 the trigger channel 12 branches-off from the outlet downstream of the functional chamber 40. The trigger channel 12 joins the outlet channel 14 at a joining location below the geometric valve 1 given in greater detail in FIGS. 3-7. FIG. 10 shows an embodiment of a functional chamber 40, the outlet of which is arranged as a plurality 42 of parallel channels 41 each having a non-closing valve. A pillar-array may be integrated within the functional chamber 40.

The trigger channel 12 joins the outlet channel 14 at the joining location 17 (see embodiments according to FIGS. 3-7). Depending on the cross section 13 and the length of the trigger channel 12, the residence time of liquid 19 within the functional chamber 40 can be increased, e.g., to allow for performance of chemical reactions within the functional chamber 40, or in the alternative to allow for dissolving of dried reagents within the functional chamber 40 of the microfluidic device according to the present invention.

FIG. 11 shows a different embodiment of a microfluidic device, comprising a functional chamber 40. According to this embodiment, an elongated trigger channel 43 circumvents the functional chamber 40. The first circumventing trigger channel 43 branches-off at a second branch-off location 45 prior to the entry of the inlet channel 10 into a functional chamber 40. In this embodiment, the circumventing trigger channel 43 branches-off from the first channel 10 upstream of the functional chamber 40. The first circumventing trigger channel 43 joins the outlet channel 14 below an arrangement of parallel channels 42 having a non-closing valve element below the functional chamber 40. The first circumventing trigger channel 43 branching-off at the respective second branch-off location 45 allows for a branching-off of liquid, prior to the entry thereof into the functional chamber 40. The liquid 19 contained within the first circumventing trigger channel 43 does not contain any functionalized liquid of functional chamber 40, but rather is pure liquid 19. Consequently, the amount of liquid contained within the functional chamber 40 can be fully used without having any portion thereof to be branched-off into the respective trigger channel 12 as in the embodiments given in FIGS. 9 and 10, respectively.

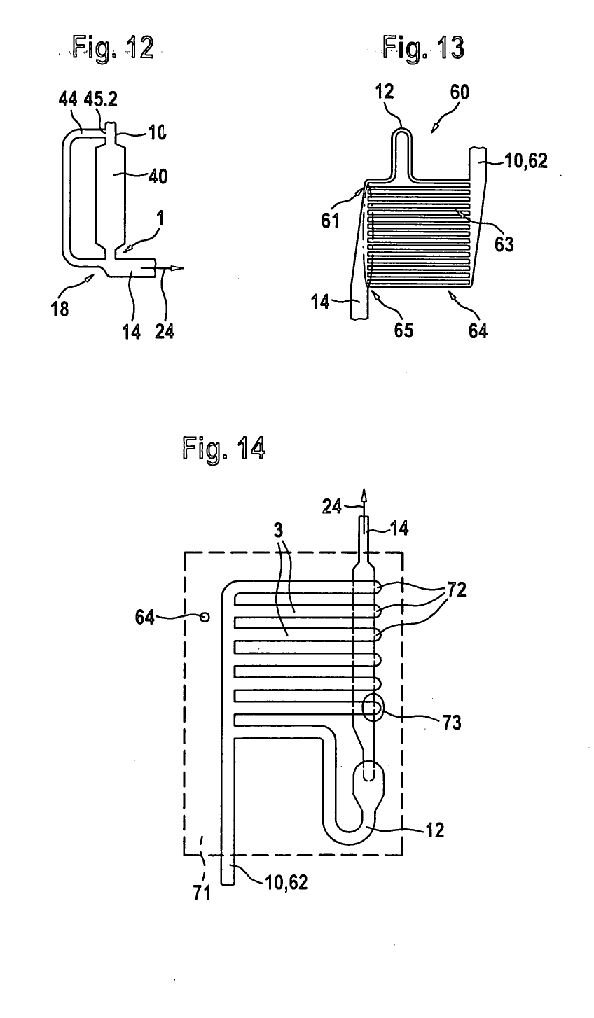

FIG. 12 shows a further embodiment of a functional chamber integrated into a microfluidic device according to the present invention.

In the embodiment according to FIG. 12 a second circumventing trigger channel 44 branches-off at second branch-off location 45 arranged above the entry of inlet channel 10 into the functional chamber 40, i.e., upstream of the functional chamber 40. The second circumventing trigger channel 44 joins the outlet channel 14 within an area 18. Within the outlet channel 14 of the functional chamber 40 according to the embodiment of FIG. 12 a non-closing valve 1 such as a geometric valve is integrated. Reference numeral 24 depicts the flow direction of the main flow from the functional chamber 40, once the second circumventing trigger channel 44 is entirely filled with the liquid 19.

FIG. 13 shows a planar design of a flow-splitter device according to the present invention. Reagents are often deposited in microfluidic channels as described above and are dissolved with a liquid 19. The speed of the dissolving procedure is limited by the diffusion of the involved molecules. Generally, in microfluidic systems there is no turbulent flow, i.e., the intermixing of molecules is process-limited mainly by diffusion. A further aspect is the solubility of the product of reagent and the solvent. With the flow-splitter devices according to the present invention the surface to volume ratio of a flow-splitter device, embodied as a microfluidic device can be significantly increased. With the embodiments of a flow-splitter device described in more detail below, an inlet channel generally is split into several channels which increases the surface to volume ratio. The solution according to the present invention offers the advantage to join the liquid 19 flowing in these splitted channels in one single outlet channel again in a controlled manner without introducing or producing bubbles within the outlet flow. Additionally, it slows down the liquid flow in the splitted channels.

The embodiment according to FIG. 13 shows a planar design which may by replicated in plastics as shown in greater detail. A first flow-splitter device is identified by reference numeral 60 and comprises an inlet channel 10, 62, respectively. The planar design according to FIG. 13 includes an array 64 of splitted channels 63. The splitted channels 63 extend substantially in parallel to one another. The first flow-splitter device 60 comprises the trigger channel 12. Each of the splitted channels 63 has at least one non-closing valve 65 located downstream of the branch-off of the second channel 12, i.e., the trigger channel. The trigger channel 12 re-unites with each of the splitted channels 63 of the array 64 downstream of the non-closing valves 65 to form an outlet channel 14. Each of the splitted channels 63 opens into a common outlet channel 14. The openings of each of the splitted channels 63 constitute a non-closing valve 65. The trigger point of the array 64 of splitted channels 63 is identified with reference numeral 61. Once the liquid 19 enters the first flow-splitter device 60 and has entered into the trigger channel 12 and the respective splitted channels 63, the liquid in the respective splitted channels 63 stops at a non-closing valve 65 one of which is arranged at each end of the respective splitted channels 63. When liquid flow to trigger channel 12 reaches the trigger point 61, liquid flow begins in a sequential manner beginning in the splitted channel 63 which is arranged closest to the respective trigger point 61. The liquid 19 flowing—according to the embodiment given in FIG. 13—in vertical direction downwards, fills the common outlet channel 14, the cross-section of which gradually increases in liquid flow direction out of the first flow splitter devices 60.

FIG. 14 shows a further embodiment of a flow-splitter device within which geometric stop valves are generated by means of overlapping.

The embodiment of a flow-splitter device according to FIG. 14 shows a common inlet channel 10, 62 respectively, which is split up into a plurality of splitted channels 63, forming a splitted channel array 64. The splitted channels 63 substantially extend in parallel to one another. The flow-splitter device according to FIG. 14 is in general a planar design which may be etched into a substrate 3 such as a very thin steel foil. In the embodiment according to FIG. 14, the substrate 3 such as a steel foil is etched on both sides thereof. Thus, the splitted channels 63 on one side of the foil 71 overlap etched channels on the rear-side on the foil 71 according to FIG. 14, thus forming overlapping regions 72 at the end of each splitted channel 63. In the overlapping region 72 which is arranged at the respective joining locations into a common outlet channel 14, geometric valves 73 are established. The array 64 of splitted channels 63 is connected to the common outlet channel 14 on the backside of the foil 71 by means of an opening connecting the trigger channel 12 arranged on the front side of the foil 71 with the common outlet channel 14 arranged on the respective other side of the foil 71. With this embodiment of a flow splitter device a change of planes, i.e., from the front side to the rearside and vice versa, can be achieved. The single splitted channels 63 each comprise an end portion which is formed as a geometric (non-closing) valve 73.

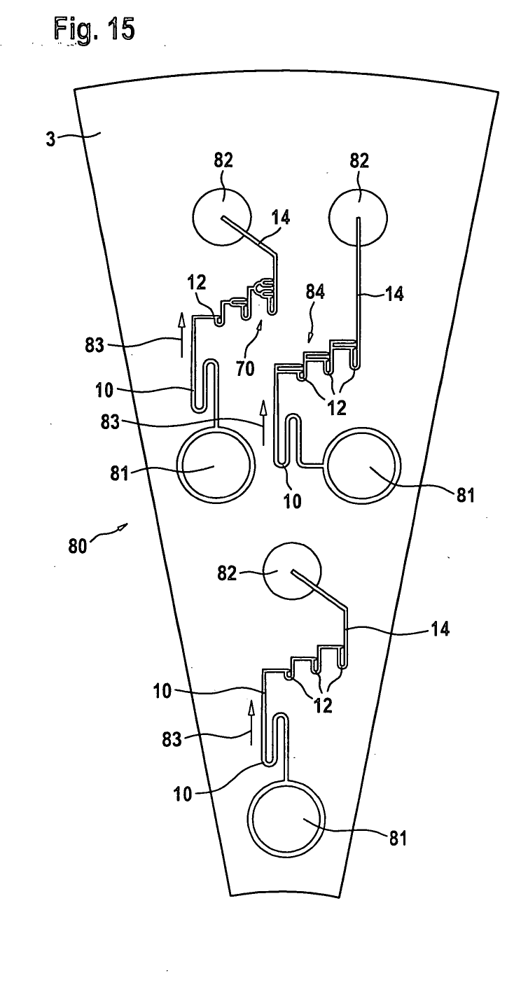

FIG. 15-17 show fluidic trigger structures to be replicated in plastics for fluidic evaluation.

FIG. 15 shows a support-structure 3 such as an injection moulded or hot embossed substrate or the like. On the top-side of the support-structure 3 according to FIG. 15 three different microfluidic systems are arranged.

On the support-structure section 3 shown in FIG. 15 the different microfluidic systems for evaluation of liquid are arranged. Each of the three systems comprises a liquid supply 81 and a liquid reservoir 82, respectively. Liquid is fed from the liquid supply 81 in flow direction 83 via the inlet channel 10 to a flow splitter device, which according to FIG. 15 is shaped in a cascade arrangement 84. To each of the stages of the cascade arrangement 84 an individual trigger-channel 12 is assigned to allow for bubble free flow via outlet channel 14 into the liquid reservoir 82. The branches, comprised in the cascade arrangement 84 according to FIG. 15 may vary between 2 and 4 each being triggered by a trigger channel 12 arranged to the respective cascade 84.

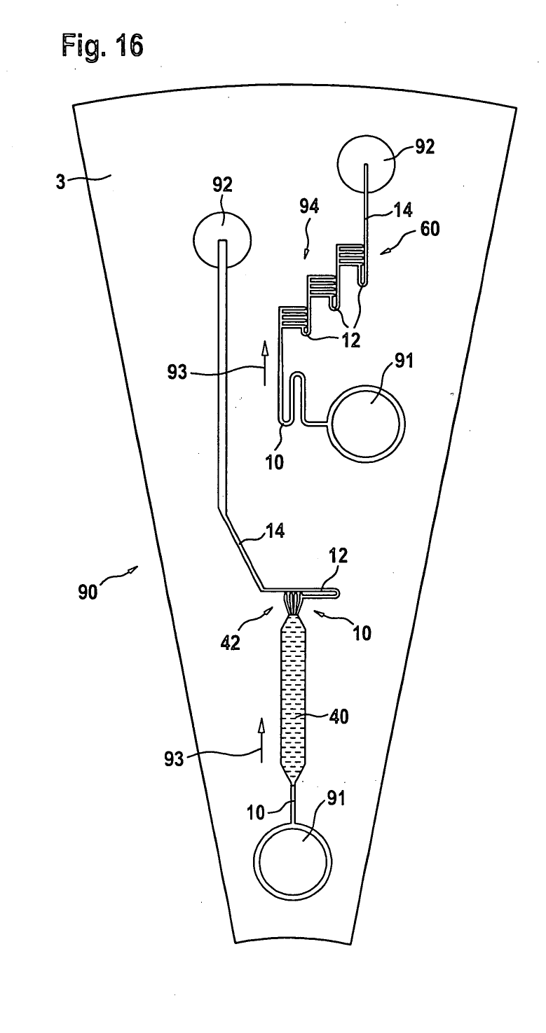

FIG. 16 shows a second liquid trigger structure according to the present invention arranged on a support-structure element 3.

The support-structure element 3 may be as previously mentioned a plastic material into which the microfluidic devices according to FIG. 16 may be replicated.

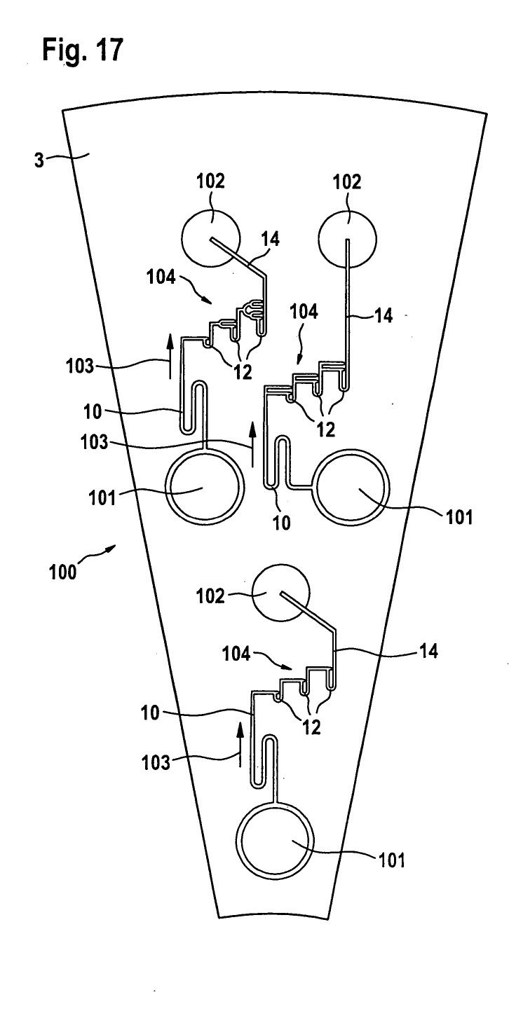

In contrast to the first fluidic trigger structure 80 according to FIG. 15, the second fluidic trigger structure 90 according to FIG. 16 comprises two microfluidic systems. One of the microfluidic systems given on the support-structure element 3 according to FIG. 16 comprises a functional chamber 40, which is fed by an inlet channel 10 from a liquid supply 91. The flow direction of the liquid is indicated by arrow 93. A portion of the liquid contained in the functional chamber 40 enters into the trigger channel 12 assigned to a series of four outlet channels (array 42) of the functional chamber 40 each of the outlet channels having a non-closing valve. The outlet of the functional chamber 40 constitutes the inlet with respect to the trigger channel 12. The length and the cross section of the trigger channel 12 assigned to the functional chamber 40 determines the residence time of the liquid 19 contained in the functional chamber 40. Further, in the embodiment of a second fluidic trigger structure 90 according to FIG. 16 a flow-split device 60 is integrated. From the liquid supply 91 liquid is fed in flow direction 93 via inlet channel 10 to a first flow-splitter device 60 having a cascade arrangement 94. Each of the cascades comprises four microchannels in parallel to one of which a trigger channel 12 is assigned to allow for bubble-free conveying of liquid to the reservoir 92. It should be understood, that each outlet of a previous cascade 84, 94, 104, constitutes the inlet for the following cascade of the cascade arrangement 94 of the first flow-splitter device 60 according to the embodiments given in FIGS. 16 and 17, respectively.

In the embodiment according to FIG. 17 a third liquid trigger structure according to the present invention is arranged on a support structure element 3.

According to this embodiment, liquid contained within a liquid supply 101 flows via inlet channel 10 in flow direction 103 to a reservoir 102. The inlet channel 10 is connected to a cascade arrangement 104 having three (3) trigger channels 12 assigned thereto. According to the third liquid trigger structure 100, as given in FIG. 17, the substrate 3 comprises further trigger structures by means of which liquid from liquid supply 101 is transmitted to a reservoir 102. In one embodiment given on the substrate 3 according to FIG. 17 the cascade arrangement 104 comprises flow splitter devices to each of which a respective trigger channel 12 is assigned. On the right hand side on top of FIG. 17 a cascade arrangement 104 is shown which comprises two channels extending parallel to one another. According to this embodiment to each of the pair of channels extending substantially parallel to one another a separate trigger channel 12 is assigned.

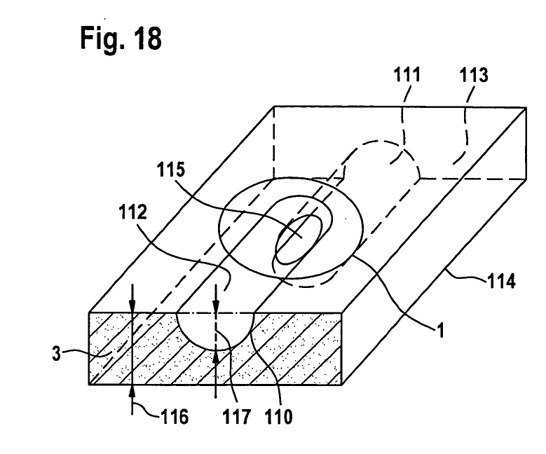

FIG. 18 schematically shows a non-closing valve as previously mentioned herein. According to the embodiment of a non-closing valve 1, a first channel 110 is etched into a front side 113 of a thin substrate 3 having a thickness 116. The first channel 110 is connected to a second channel 111 on the backside 114 of the thin substrate 3, made for instance of a very thin, etchable steel foil, a polyimide-foil, or the like. The first channel 110 and the second channel 111 are connected to one another by an opening 115. The depth of the first channel 110 is identified by reference numeral 117. The second channel 111, etched on the respective backside 114 of the very thin substrate 3 has a similar depth. Both the depth 117 of the first channel 110 and the depth of the second channel 111 are chosen that both channels 110, 111 establish a fluid communication, thus allowing for a transfer of liquid via opening 115 from the front side 113 of the very thin substrate 3 to the respective backside 114 thereof. The channels' surfaces are labelled 112.

The microfluidic devices according to the present invention may be used for processing human blood, liquor or other body fluid samples, aqueous solutions of reagents, liquids containing organic solutions or oil. The microfluidic devices according to the present invention can be used for the extension of incubation time or reaction time, to allow for enhancing the residence time of liquid 19 to dissolve dried reagents, which are for example contained within the functional chamber 40.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A microfluidic device comprising:
i) a liquid supply compartment;
ii) a first channel connected to the liquid supply compartment and having at least one non-closing valve located downstream of the liquid supply compartment; and
iii) a second channel that branches-off from the first channel downstream of the liquid supply compartment but upstream of the at least one non-closing valve and that re-unites with the first channel at the location of the non-closing valve to form an outlet channel, wherein
the second channel does not contain any non-closing or closing valve thus creating an unobstructed liquid flow path connecting the liquid supply compartment with the outlet channel.

2. The microfluidic device of claim 1, wherein the second channel is a trigger channel to control the flow of liquids from the first channel to the outlet channel.

3. The microfluidic device of claim 1, wherein the second channel has a width or a diameter which is smaller than the width or diameter of the first channel.

4. The microfluidic device of claim 1, wherein the second channel has a length exceeding the length of the flow path of the liquid from the branch-off location to the non-closing valve.

5. The microfluidic device of claim 1, wherein the non-closing valve is a geometric valve.

6. The microfluidic device of claim 1, wherein the first channel and the outlet channel are connected by the non-closing valve and wherein the second channel branches-off upstream of the non-closing valve and joins the outlet channel at the outlet of the non-closing valve.

7. The microfluidic device of claim 1, wherein the functional chamber is provided which comprises dried reagents.

8. The microfluidic device of claim 7, wherein the second channel branches-off from the first channel upstream of the functional chamber.

9. The microfluidic device of claim 7, wherein the second channel branches-off from the first channel downstream of the functional chamber.

10. The microfluidic device of claim 7, wherein the second channel joins the outlet channel downstream of the functional chamber.

11. The microfluidic device of claim 1, wherein the first channel is split into the second channel and an array of at least two splitted channels each of the splitted channels having at least one non-closing valve located downstream of the branch-off of the second channel and wherein the second channel re-unites with each of the splitted channels of the array downstream of the non-closing valve to form an outlet channel.

12. The microfluidic device of claim 1, wherein the inlet channel is split into an array of splitted channels arranged on both sides of a planar structure.

13. The microfluidic device of claim 12, wherein geometric valves are formed at the locations where the splitted channels on both sides of the planar structure overlap.
